(19) United States
(12) Patent Application Publication
(10) Pub. No.: US 2025/0217679 A1
(43) Pub. Date: Jul. 3, 2025

(54) METHOD AND APPARATUS FOR PERFORMING DATA FRAGMENTATION ON KNOWLEDGE GRAPH

(71) Applicant: Alipay (Hangzhou) Information Technology Co., Ltd., Hangzhou (CN)

(72) Inventor: Xiaopei WAN, Hangzhou (CN)

(21) Appl. No.: 18/850,921

(22) PCT Filed: Jan. 4, 2023
(86) PCT No.: PCT/CN2023/070483

§ 371 Date: Sep. 25, 2024

(30) Foreign Application Priority Data
Mar. 28, 2022 (CN) 202210312004.8

(51) Int. Cl. G06N 5/043

(52) U.S. Cl. CPC G06N 5/043

(57) ABSTRACT

Embodiments of this specification provide methods and apparatuses for performing data fragmentation on a knowledge graph. The method is used to split a knowledge graph into a plurality of pieces of data respectively included in a plurality of devices. First, initial splitting is performed on a plurality of edges in the knowledge graph. Any first device selects a diffusion node from end nodes of a first part of edges; obtains, as a to-be-fragmented edge, an edge that is in the knowledge graph and that uses the diffusion node as an end node on one side; and adds a target edge in the to-be-fragmented edge to first fragmented data of the first device. Then, the first device obtains a fragmented node in fragmented data of another device; adjusts the first diffusion velocity; and continues to select a diffusion node based on an adjusted first diffusion velocity, and cyclically performs the step.

This specification claims priority to Chinese Patent Application No. 202210312004.8, filed with the China National Intellectual Property Administration on Mar. 28, 2022 and entitled “METHOD AND APPARATUS FOR PERFORMING DATA FRAGMENTATION ON KNOWLEDGE GRAPH”, which is incorporated herein by reference in its entirety.

### TECHNICAL FIELD

One or more embodiments of this specification relate to the field of data processing technologies, and in particular, to methods and apparatuses for performing data fragmentation on a knowledge graph.

### BACKGROUND

Knowledge graphs are knowledge bases that express knowledge in a form of a multi-relation graph formed by nodes and edges. Generally, knowledge graphs use nodes to represent entities and use edges between nodes to express “relations” between entities. Entities refer to things in a real world, such as people, place names, concepts, medicines, or companies, and edges are used to express certain connections between different entities. For example, an edge such as “Zhang San”-“Lives in”-“Beijing” in the knowledge graph includes two end nodes. Expressing knowledge in a form of a knowledge graph can be applied in fields such as search and information query, thereby greatly improving accuracy of search and query.

Generally, a large-scale knowledge graph includes a large quantity of edges and nodes, and an extremely large amount of data of the large-scale knowledge graph cannot be stored in one device. The knowledge graph needs to be individually stored in different devices, and needs such as data storage and data query are resolved through distributed storage. To store a large-scale knowledge graph in a distributed manner, data fragmentation needs to be performed on the large-scale knowledge graph, so that a plurality of devices respectively obtain data fragments satisfying needs.

Therefore, it is expected that there is an improved solution to better control a data fragmentation process for a knowledge graph, making fragmented data allocated to a plurality of devices more balanced.

### SUMMARY

One or more embodiments of this specification describe methods and apparatuses for performing data fragmentation on a knowledge graph, to better control a data fragmentation process for a knowledge graph, making fragmented data allocated to a plurality of devices more balanced. Specific technical solutions are as follows.

According to a first aspect, one or more embodiments provide a method for performing data fragmentation on a knowledge graph, used to split a knowledge graph into a plurality of pieces of fragmented data, where the plurality of pieces of fragmented data are included in a plurality of devices, and the knowledge graph includes a plurality of nodes representing entities and edges reflecting relations between nodes. The method is performed by any first device in the plurality of devices and includes:
obtaining a first part of edges of the knowledge graph, where the first part of edges are obtained after initial splitting is performed on a plurality of edges of the knowledge graph; selecting a diffusion node from end nodes of the first part of edges based on a first diffusion velocity; obtaining, as a to-be-fragmented edge, an edge that is in the knowledge graph and that uses the diffusion node as an end node on one side; adding a target edge in the to-be-fragmented edge to first fragmented data, where the first fragmented data is included in the first device, and the first fragmented data includes a fragmented edge; obtaining an end node included in a fragmented edge in fragmented data of another device as a fragmented node of the other device; adjusting the first diffusion velocity based on comparison between a fragmented node of the first device and the fragmented node of the other device; and continuing to select a diffusion node based on an adjusted first diffusion velocity, and returning to perform the step of obtaining an edge that is in the knowledge graph and that uses the diffusion node as an end node on one side.

In an implementation, a value of the first diffusion velocity is between (0, 1], and is used to represent a selected quantity proportion.

In an implementation, the step of selecting a diffusion node from end nodes of the first part of edges based on a first diffusion velocity includes: selecting a first quantity of nodes from the end nodes of the first part of edges as initial boundary points; sorting the plurality of initial boundary points in ascending order of quantities of edges associated with the initial boundary points; and selecting the diffusion node from a plurality of sorted initial boundary points based on the first diffusion velocity.

In an implementation, the quantity of edges associated with the initial boundary point is determined by using the following method: obtaining an edge that is in another device and that uses the initial boundary point as an end node on one side, where the other device includes a device different from the first device in the plurality of devices, and the obtained edge is determined by the other device from a part of edges owned by the other device; and determining, for any initial boundary point, the quantity of edges associated with the initial boundary point based on a sum of a quantity of edges that are in the first part of edges and that use the initial boundary point as an end node on one side and a quantity of edges that are in the other device and that use the initial boundary point as an end node on one side.

In an implementation, the step of obtaining an edge that is in the knowledge graph and that uses the diffusion node as an end node on one side includes: obtaining an edge that uses the diffusion node as an end node on one side from a part of edges owned by another device; and determining, as the edge that is in the knowledge graph and that uses the diffusion node as an end node on one side, an edge that is in the obtained edge and the first part of edges and that uses the diffusion node as an end node on one side.

In an implementation, the target edge is determined from the to-be-fragmented edge in the following way: selecting the target edge from the to-be-fragmented edge based on the first diffusion velocity.

In an implementation, the method further includes: receiving an obtaining request sent by another device, where the obtaining request is used to obtain the fragmented node of the first device; and sending the fragmented node of the first device to the other device, so that the other device adjusts a diffusion velocity of the other device based on the fragmented node of the first device.

In an implementation, the step of continuing to select a diffusion node based on an adjusted first diffusion velocity includes: selecting the diffusion node from an end node on the other side of the target edge based on the adjusted first diffusion velocity; or selecting the diffusion node from an unselected end node in the first part of edges based on the adjusted first diffusion velocity.

In an implementation, the step of adjusting the first diffusion velocity based on comparison between a fragmented node of the first device and the fragmented node of the other device includes: decreasing the first diffusion velocity by using a first correction factor when it is determined, based on comparison between a quantity of fragmented nodes of the first device and a quantity of fragmented nodes of the other device, that a node fragmentation progress of the first device is greater than a first predetermined progress.

In an implementation, the following way is used to determine that the node fragmentation progress of the first device is greater than the first predetermined progress: determining that the node fragmentation progress of the first device is greater than the first predetermined progress when the quantity of fragmented nodes of the first device is greater than an average quantity of fragmented nodes of the plurality of devices, and a node balance degree of the first device is greater than a predetermined node balance degree, where the average quantity of fragmented nodes and the node balance degree are determined based on quantities of fragmented nodes of the plurality of devices.

In an implementation, the method further includes: increasing the first diffusion velocity by using the first correction factor when it is determined, based on comparison between the quantity of fragmented nodes of the first device and the quantity of fragmented nodes of the other device, that the node fragmentation progress of the first device is less than a second predetermined progress.

In an implementation, the following way is used to determine that the node fragmentation progress of the first device is less than the second predetermined progress: determining that the node fragmentation progress of the first device is less than the second predetermined progress when the quantity of fragmented nodes of the first device is not greater than an average quantity of fragmented nodes, and a maximum node balance degree in the plurality of devices is greater than a predetermined node balance degree.

In an implementation, the step of decreasing the first diffusion velocity by using a first correction factor includes:
decreasing the first diffusion velocity according to a logarithmic rule of the first correction factor.

In an implementation, the first correction factor is determined based on comparison between the quantity of fragmented nodes of the first device and an average quantity of fragmented nodes of the plurality of devices.

In an implementation, before the adjusting the first diffusion velocity, the method further includes:
obtaining a fragmented edge in fragmented data of another device; and
the step of adjusting the first diffusion velocity includes:
adjusting the first diffusion velocity based on comparison between the fragmented node of the first device and a fragmented node of the other device, and comparison between the fragmented edge of the first device and the fragmented edge of the other device.

In an implementation, the step of adjusting the first diffusion velocity includes: preliminarily adjusting the first diffusion velocity based on comparison between the fragmented node of the first device and the fragmented node of the other device; and continuing to adjust the adjusted first diffusion velocity based on comparison between the fragmented edge of the first device and the fragmented edge of the other device.

In an implementation, the step of continuing to adjust the adjusted first diffusion velocity based on comparison between the fragmented edge of the first device and the fragmented edge of the other device includes: decreasing the adjusted first diffusion velocity by using a second correction factor when it is determined, based on comparison between a quantity of fragmented edges of the first device and a quantity of fragmented edges of the other device, that an edge fragmentation progress of the first device is greater than a third predetermined progress.

In an implementation, the following way is used to determine that the edge fragmentation progress of the first device is greater than the third predetermined progress:
determining that the edge fragmentation progress of the first device is greater than the third predetermined progress when the quantity of fragmented edges of the first device is greater than an average quantity of fragmented edges of the plurality of devices, and an edge balance degree of the first device is greater than a predetermined edge balance degree, where the average quantity of fragmented edges and the edge balance degree are determined based on quantities of fragmented edges of the plurality of devices.

In an implementation, the method further includes: increasing the adjusted first diffusion velocity by using the second correction factor when it is determined, based on comparison between the quantity of fragmented edges of the first device and the quantity of fragmented edges of the other device, that the edge fragmentation progress of the first device is less than a fourth predetermined progress.

In an implementation, the following way is used to determine that the edge fragmentation progress of the first device is less than a fourth predetermined progress:
determining that the edge fragmentation progress of the first device is less than the fourth predetermined progress when the quantity of fragmented edges of the first device is not greater than an average quantity of fragmented edges, and a maximum edge balance degree in the plurality of devices is greater than a predetermined edge balance degree.

In an implementation, the step of decreasing the adjusted first diffusion velocity by using a second correction factor includes:
decreasing the adjusted first diffusion velocity according to a logarithmic rule of the second correction factor.

In an implementation, the second correction factor is determined based on comparison between the quantity of fragmented edges of the first device and an average quantity of fragmented edges of the plurality of devices.

According to a second aspect, one or more embodiments provide an apparatus for performing data fragmentation on a knowledge graph, configured to split a knowledge graph into a plurality of pieces of fragmented data, where the plurality of pieces of fragmented data are included in a plurality of devices, and the knowledge graph includes a plurality of nodes representing entities and edges reflecting relations between nodes. The apparatus is deployed in any first device in the plurality of devices and includes:
a first acquisition module, configured to obtain a first part of edges of the knowledge graph, where the first part of edges are obtained after initial splitting is performed on a plurality of edges of the knowledge graph; a first selection module, configured to select a diffusion node from end nodes of the first part of edges based on a first diffusion velocity; a second acquisition module, configured to obtain, as a to-be-fragmented edge, an edge that is in the knowledge graph and that uses the diffusion node as an end node on one side; a first fragmentation module, configured to add a target edge in the to-be-fragmented edge to first fragmented data, where the first fragmented data is included in the first device, and the first fragmented data includes a fragmented edge; a third acquisition module, configured to obtain an end node included in a fragmented edge in fragmented data of another device as a fragmented node of the other device; a first adjustment module, configured to adjust the first diffusion velocity based on comparison between a fragmented node of the first device and the fragmented node of the other device; and a second selection module, configured to continue to select a diffusion node based on an adjusted first diffusion velocity, and return to perform the second acquisition module.

According to a third aspect, one or more embodiments provide a computer-readable storage medium. The computer-readable storage medium stores a computer program, and when the computer program is executed in a computer, the computer is enabled to perform the method in any implementation of the first aspect.

According to a fourth aspect, one or more embodiments provide a computing device, including a memory and a processor. The memory stores executable code, and when executing the executable code, the processor implements the method in any implementation of the first aspect.

In the methods and the apparatuses provided in the embodiments of this specification, when data fragmentation is performed on a knowledge graph, diffusion and fragmentation is performed starting from a diffusion node in a direction of a neighbor node of the diffusion node. A device can adjust a diffusion velocity of the device based on comparison between a fragmented node of the device and a fragmented node of another device, so that a quantity of fragmented nodes is controlled by controlling the diffusion velocity. In other words, in the embodiments of this specification, the knowledge graph is split based on a quantity of edges, and the diffusion velocity is adaptively modified by comparing fragmented nodes in a plurality of devices, so that quantities of nodes allocated to the plurality of devices reaches a needed balance, and quantities of nodes and quantities of edges in fragmented data allocated to the plurality of devices are more balanced.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following description show merely some embodiments of this specification, and a person of ordinary skill in the art can still derive other drawings from these accompanying drawings without creative efforts.

FIG. 1 is a schematic diagram illustrating an implementation scenario, according to one or more embodiments of this specification;

FIG. 2 is a schematic flowchart illustrating a method for performing data fragmentation on a knowledge graph, according to one or more embodiments;

FIG. 3 is a schematic flowchart illustrating another method for performing data fragmentation on a knowledge graph, according to one or more embodiments;

FIG. 4 is a schematic block diagram illustrating an apparatus for performing data fragmentation on a knowledge graph, according to one or more embodiments; and

FIG. 5 is a schematic block diagram illustrating another apparatus embodiment, according to one or more embodiments.

### DESCRIPTION OF EMBODIMENTS

The solutions provided in this specification are described below with reference to the accompanying drawings.

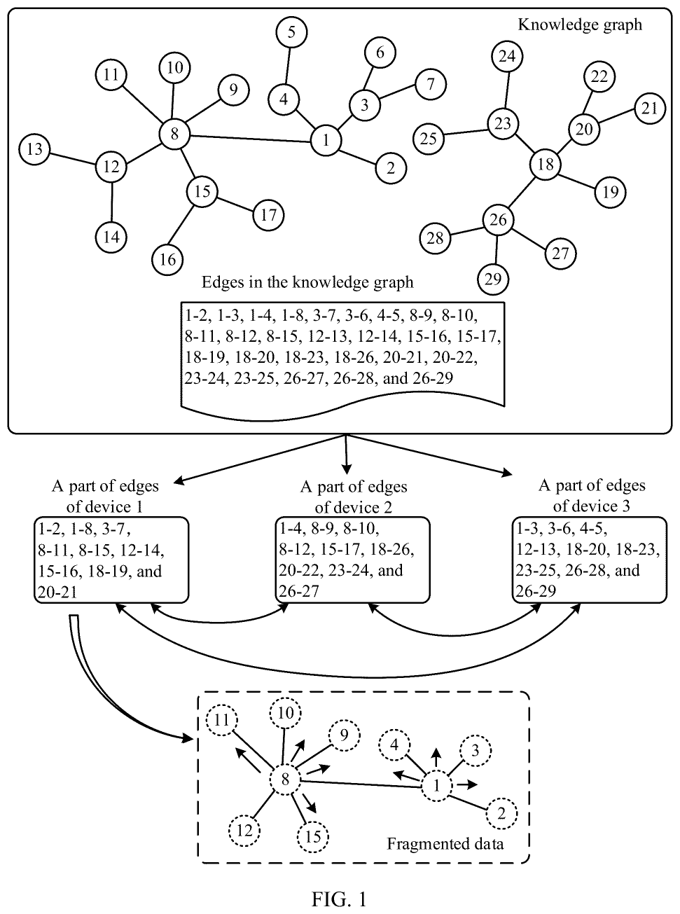

FIG. 1 is a schematic diagram illustrating an implementation scenario, according to one or more embodiments of this specification. A knowledge graph includes nodes representing entities and edges representing relations between nodes, and includes a plurality of nodes and a plurality of edges. In FIG. 1, a circle represents a node, where a number in the circle represents a node number, for example, node 1 to node 29; and a connecting line between two nodes represents an edge, for example, “1-2”, “1-3”, etc. represents two edges. First, full data of the knowledge graph is initially split, and all edges of the knowledge graph are randomly averaged and stored in device 1 to device 3. For example, a part of edges allocated to device 1 include 1-2, 1-8, 3-7, 8-11, 8-15, 12-14, 15-16, 18-19, and 20-21, and a part of edges are allocated to each of device 2 and device 3. Then, each device selects, based on a certain diffusion velocity (representing a selected quantity proportion), a certain quantity proportion of diffusion nodes from end nodes included in a part of edges owned by the device, starts to diffuse from these diffusion nodes, and determines diffused edges as fragmented data of the device. For example, device 1 diffuses in a direction of the edge starting from node 1 and node 8. In each time of diffusion, quantities of fragmented nodes are exchanged between devices, and a diffusion velocity is adjusted based on a difference between the quantities of fragmented nodes of the devices. Finally, quantities of nodes in fragmented data of a plurality of devices are relatively balanced, and edges that have a neighbor relation are distributed to the same device as much as possible. Information such as the knowledge graph and the plurality of devices in FIG. 1 is merely an example, and does not constitute a limitation on this specification.

The following describes related concepts and implementation scenarios of this specification in detail with reference to FIG. 1.

A knowledge graph is a knowledge base expressed in a form of a graph, and can express large and complex knowledge in a more orderly way. The knowledge graph can be applied to a plurality of fields, for example, can be applied to a semantic-based search field, applied to a recommendation field, or applied to generation of a user profile. When the knowledge graph is applied to the search field, the knowledge graph can be searched for a to-be-searched entity, and data related to the to-be-searched entity is obtained based on a relation between entity nodes. When the knowledge graph is applied to the recommendation field, a to-be-recommended entity can be determined from the knowledge graph, data related to the to-be-recommended entity is obtained based on a relation between entity nodes, and the to-be-recommended entity is recommended based on the data. When a user profile is generated, related data of entity nodes can be obtained by using a relation between the entity nodes, and the user profile is generated by using the related data.

The knowledge graph includes a plurality of nodes and connecting edges between nodes. The node represents an entity. Therefore, the node can also be referred to as an entity node. The connecting edge between nodes is used to represent a relation between entities. Entities refer to things in a real world, such as people, place names, concepts, medicines, companies, organizations, institutions, devices, numbers, dates, currencies, and addresses, which are countless. The entity can be represented by an entity word, and the entity word has a noun property. For example, a user's nickname Zhang San, address Beijing, etc. are all entities. The relation is used to express a certain connection between different entities. For example, “Zhang San”-“Lives in”-“Beijing” reflects relation data such as “Zhang San lives in Beijing”.

The knowledge graph can be constructed by using service data, for example, can be constructed by using service data related to the following objects: stores, users, products, events, etc. In a large-scale knowledge graph, nodes and edges are very large in quantity and usually cannot be stored by one device. To satisfy storage and query needs of the large-scale knowledge graph, the knowledge graph can be individually stored in different devices, and data storage and query needs are resolved through distributed storage.

Generally, data of the large-scale knowledge graph can be individually stored in a plurality of devices, and configurations such as storage space and computing capabilities of these devices are basically the same. When processing query or another request for the large-scale knowledge graph, the request should be performed in the plurality of devices, which needs load balancing. In other words, quantities of edges and quantities of nodes of fragmented data of the knowledge graph stored in the plurality of devices should be approximately balanced. This is a need for splitting the knowledge graph, that is, a principle of balance between nodes and edges.

In another aspect, to improve efficiency of query or other processing, neighboring nodes and neighboring edges should be put into fragmented data of the same device through splitting as much as possible. This is another need for splitting the knowledge graph, that is, a neighbor diffusion principle.

To better control a data fragmentation process for a knowledge graph, making fragmented data allocated to a plurality of devices more balanced, and conform to the neighbor diffusion principle as much as possible, one or more embodiments provide a method for performing data fragmentation on a knowledge graph. The method is performed by any first device in a plurality of devices and includes the following steps: Step S210: Obtain a first part of edges of a knowledge graph, where the first part of edges are obtained after initial splitting is performed on a plurality of edges of the knowledge graph. Step S220: Select a diffusion node from end nodes of the first part of edges based on a first diffusion velocity. Step S230: Obtain, as a to-be-fragmented edge, an edge that is in the knowledge graph and that uses the diffusion node as an end node on one side. Step S240: Add a target edge in the to-be-fragmented edge to first fragmented data, where the first fragmented data is included in the first device, and the first fragmented data includes a fragmented edge. Step S250: Obtain an end node included in a fragmented edge in fragmented data of another device as a fragmented node of the other device. Step S260: Adjust a first diffusion velocity based on comparison between a fragmented node of the first device and the fragmented node of the other device. Step S270: Continue to select a diffusion node based on an adjusted first diffusion velocity, and return to perform step S230 to obtain an edge that is in the knowledge graph and that uses the diffusion node as an end node on one side.

In the one or more embodiments, in a process of performing diffusion and fragmentation on the edges of the knowledge graph, the first device adjusts a diffusion velocity of the first device based on a difference between the fragmented node of the first device and a fragmented node of another device, and dynamically adjusts the diffusion velocity, so that the fragmented node of the first device and the fragmented node of the other device reach a relatively balanced state.

In the knowledge graph, the node represents an entity, and each node can include an entity type, an entity attribute, and other data. The edge between nodes can include a relation type, a relation attribute, and other data. Splitting the knowledge graph into a plurality of pieces of data includes division of all data included in the knowledge graph. However, division of all the data in the knowledge graph is based on division of nodes and edges, and division of the nodes node is based on division of the edges. Therefore, in the one or more embodiments, overall data in the knowledge graph can be split based on division of the edges in the knowledge graph. In addition, in a process of performing data fragmentation on the knowledge graph, the nodes and the edges that are represented in a number form can be first divided. When this process is completed, data of a node and an edge that corresponds to a corresponding number in the knowledge graph is stored in a corresponding device.

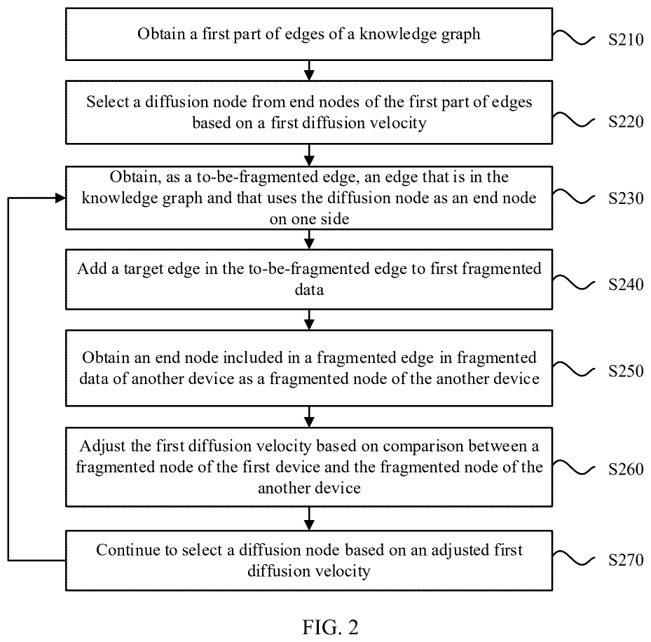

The following describes the foregoing one or more embodiments in detail with reference to FIG. 2.

FIG. 2 is a schematic flowchart illustrating a method for performing data fragmentation on a knowledge graph, according to one or more embodiments. The method is used to split a knowledge graph into a plurality of pieces of data, and the plurality of pieces of data are included in a plurality of devices respectively. Configurations such as storage space and computing capabilities of the plurality of devices can be the same or can be different. The plurality of devices can also be understood as a plurality of devices in a logical sense. Any device can be implemented by any apparatus, device, platform, device cluster, etc. having a computing and processing capability.

The knowledge graph includes a plurality of nodes representing entities and edges representing relations between the nodes. The knowledge graph is a to-be-split knowledge graph. Initially, full data of the knowledge graph can be stored in one supercomputer, or can be individually stored in a plurality of devices in unequal data amounts. The method embodiment is performed by any first device A in N devices, and all the N devices can perform the same process as first device A, to implement that fragmented data obtained by the N devices is relatively balanced. N can be 2 or an integer greater than 2. The method includes the following steps.

In step S210, first device A obtains a first part of edges1 of the knowledge graph. The first part of edges1 is obtained after initial splitting is performed on a plurality of edges in the knowledge graph. Similarly, other devices different from first device A in the N devices each obtain a part of edges. Parts of edges of the knowledge graph obtained by the plurality of devices can be obtained by performing random average division on full edges of the knowledge graph.

The first part of edges1 is not fragmented data that is finally allocated to first device A, because although the first part of edges1 can reach a balance with a quantity of edges obtained by another device, quantities of nodes are not balanced, which does not conform to a neighbor diffusion principle. In a subsequent processing step, the edges of the knowledge graph are reallocated based on parts of edges respectively obtained by the N devices, so that nodes and edges in fragmented data finally obtained by the devices conform to a balance principle and the neighbor diffusion principle.

The edge in the knowledge graph can be represented by two node numbers, for example, an edge between node 1 and node 2 can be represented as 1-2. A large-scale knowledge graph can include a large quantity of edges, and sometimes includes tens or even hundreds of billions of edges. In this step, the plurality of edges in the knowledge graph are initially split, and N parts of edges obtained after splitting are stored in the N devices. For example, if the knowledge graph includes ten billion edges and there are ten devices, each device stores about one billion edges, and each device obtains a part of edges. Initial splitting performed on the plurality of edges of the knowledge graph can be performed randomly, which does not conform to the neighbor diffusion principle.

In an implementation, initially, a master device stores full edges of the knowledge graph, and the master device splits the full edges of the knowledge graph based on a quantity N of the N devices, for example, randomly splits the full edges or splits the full edges in sequence to obtain the N parts of edges, and sends the N parts of edges to the N devices respectively. To make the description more convenient, a part of edges obtained by first device A is used as the first part of edges1.

In an implementation, initially, the N devices can respectively store parts of edges of the knowledge graph. The parts of edges in the N devices may not be evenly allocated. In this case, the N devices can communicate with each other, so that the N devices respectively obtain parts of edges that are approximately evenly allocated.

For example, in the schematic scenario diagram shown in FIG. 1, it is assumed that the knowledge graph includes 27 edges, the 27 edges are randomly and evenly allocated to device 1, device 2, and device 3, and each device obtains 9 edges.

In step S220, first device A selects a diffusion node from end nodes of the first part of edges1 based on a first diffusion velocity Vₑ. The first diffusion velocity Vₑ can also be referred to as a first diffusion ratio, and is used to represent a selected quantity ratio. For example, the first diffusion velocity can be used to represent a selected node quantity ratio, or can be used to represent a selected edge quantity ratio.

For example, in FIG. 1, a part of edges of device 1 include end nodes 1, 2, 3, 7, 8, 11, 12, 14, 15, 16, 18, 19, 20, and 21. A diffusion node is selected from these end nodes based on the first diffusion velocity Vₑ, that is, a certain quantity of end nodes are selected from these end nodes based on a proportion of the first diffusion velocity as diffusion nodes. A value of the first diffusion velocity can be between (0, 1], that is, the first diffusion velocity can be a value greater than 0 and less than or equal to 1.

In the one or more embodiments, another device in the N devices also selects a diffusion node from end nodes of a part of edges of the other device based on a diffusion velocity of the other device. Initially, diffusion velocities of the N devices can be the same, for example, all can be set to 0.1.

In an implementation, when step S220 is performed, the following step 1a to step 3a can be included.

Step 1a: Select a first quantity of nodes from the end nodes of the first part of edges1 as initial boundary points to obtain a plurality of initial boundary points. The selection operation can be random selection. The first quantity can be a predetermined value, or can be modified each time diffusion iteration is performed. First quantities of the N devices can be set to the same value.

Step 2a: Sort the plurality of initial boundary points in ascending order of quantities of edges associated with the initial boundary points.

The quantity of edges associated with the initial boundary point can be understood as a quantity of all edges that use the initial boundary point as an end node one side, and can also be referred to as a degree. The plurality of initial boundary points are sorted in ascending order.

Step 3a: Select the diffusion node from a plurality of sorted initial boundary points based on the first diffusion velocity Vₑ. During selection, selection can be performed starting from a start location in a sorted sequence to select an initial boundary point with a relatively small degree as the diffusion node based on the value of the first diffusion velocity Vₑ.

In this implementation, when the diffusion node is selected, diffusion starts from a node with a small degree, which can avoid initially selecting a super hotspot as the diffusion node. The super hotspot is a node with a large quantity of associated edges.

In the foregoing step 2a, the following operation can be used to determine the quantity of edges associated with the initial boundary point:

First device A obtains an edge that is in another device and that uses the initial boundary point as an end node on one side; and determines, for any initial boundary point, the quantity of edges associated with the initial boundary point based on a sum of a quantity of edges that are in the first part of edges1 and that use the initial boundary point as an end node on one side and a quantity of edges that are in the other device and that use the initial boundary point as an end node on one side.

The other device includes a device different from first device A in the N devices, and the obtained edge is determined by the other device from a part of edges owned by the other device.

First device A can generate an obtaining request for the initial boundary point of first device A, and send the obtaining request to another device. The obtaining request is used to obtain an edge that is in the other device and that uses the initial boundary point as an end node on one side, where the obtaining request can include a number of the initial boundary point. When receiving the obtaining request, the other device sends, to first device A, an edge that is in a part of edges owned by the other device and that uses the initial boundary point included in the obtaining request as an end node on one side. The edge sent by the other device to first device A is determined from an unfragmented edge of the other device, and a fragmented edge is no longer sent to first device A.

Similarly, the other device can also send an obtaining request to first device A to obtain an edge that uses an initial boundary point in the other device as an end node on one side, and first device A also responds to the obtaining request sent by the other device.

For example, in FIG. 1, device 1 uses node 1 and node 8 as diffusion nodes, and determines, from a part of edges of device 1, edges that use the diffusion nodes as edge nodes on one side include 1-2, 1-8, 8-11, and 8-15. Device 1 can obtain, from a part of edges of device 2, edges that use node 1 and node 8 as end nodes on one side, including 1-4, 8-9, 8-10, and 8-12; and obtains, from a part of edges of device 3, edges that use node 1 and node 8 end nodes on one side, including 1-3. It is assumed that an obtaining request sent by device 1 for node 1 and node 8 is earlier than obtaining requests sent by device 2 and device 3 that have the same function. In other words, who first diffuses a node first obtains an edge associated with the node.

In the foregoing step 2a, the quantity of edges associated with the initial boundary point can alternatively be determined in another way. For example, first device A can obtain all edges that use the initial boundary point as an end node on one side from the master device that includes the full edges of the knowledge graph. After sending all the edges that use the initial boundary point as an end node on one side to first device A, the master device can further send a notification message to another device, so that the other device deletes a corresponding edge owned by the other device based on the notification message.

In the foregoing implementation for step 2a, first device A can alternatively obtain only a value of the quantity of edges that use the initial boundary point as end node on one side.

When obtaining all the edges that use the initial boundary point as an end node on one side, first device A can add these edges to the first part of edges1.

In step S230, first device A obtains, as a to-be-fragmented edge, an edge that is in the knowledge graph and that uses the diffusion node as an end node on one side. In the knowledge graph, the edge that uses the diffusion node as an end node on one side includes all edges that use the diffusion node an end node on one side. For example, in the schematic diagram shown in FIG. 1, assuming that node 1 is a diffusion node of first device A, edges 1-2, 1-3, 1-4, and 1-8 are all edges that use diffusion node 1 as an end node on one side.

First device A can obtain an edge that uses the diffusion node as an end node on one side from a part of edges owned by another device, and determine, as edges in the knowledge graph that use the diffusion node as an end node on one side, the obtained edge and an edge that is in the first part of edges1 and that uses the diffusion node as an end node on one side.

If the edge that uses the initial boundary point as an end node on one side has been obtained from another device when step S220 is performed to obtain the quantity of edges associated with the initial boundary point, because the diffusion node is selected from the initial boundary points, the edge that uses the initial boundary point as an end node on one side can be directly obtained from the edge that uses the initial boundary point as an end node on one side and that is obtained in step S220.

First device A can alternatively obtain, in another way, the edge that is in the knowledge graph and that uses the diffusion node as an end node on one side. For example, first device A can obtain all the edges that use the diffusion node as an end node on one side from the master device that includes the full edges of the knowledge graph. After sending all the edges that use the diffusion node as an end node on one side to first device A, the master device can further send a notification message to another device, so that the other device deletes a corresponding edge owned by the other device based on the notification message.

In step S240, first device A adds a target edge in a to-be-fragmented edge to first fragmented data data1.

The first fragmented data data1 is included in first device A, the first fragmented data data1 includes a fragmented edge, an end node of the fragmented edge can be referred to as a fragmented node, and the first fragmented data data1 can also include the fragmented node. Generally, a quantity of to-be-fragmented edges is very large. First device A can use all of the plurality of to-be-fragmented edges as target edges and add the to-be-fragmented edges to the first fragmented data data1. Alternatively, first device A can select a specific quantity of to-be-fragmented edges from the plurality of to-be-fragmented edges and add the to-be-fragmented edges to the first fragmented data data1 as target edges. For example, the target edge can be selected from the plurality of to-be-fragmented edges based on the first diffusion velocity Vₑ, that is, a specific proportion of edges in the plurality of to-be-fragmented edges are added to the first fragmented data data1. During implementation, the target edge can be randomly selected from the plurality of to-be-fragmented edges based on the first diffusion velocity Vₑ, or the target edge can be selected in sequence.

Adding the target edge to the first fragmented data data1 can be implemented by modifying a state of the target edge to “fragmented”. In first device A, a state of an edge that is not added to the first fragmented data data1 can be “unfragmented”.

The first fragmented data data1 is data included in first device A, and is data obtained after fragmentation. Generally, another device may no longer obtain data from the first fragmented data data1. When first device A receives an obtaining request that is sent by another device and that is used to obtain an edge that uses a certain node as an end node on one side, first device A determines the edge from an edge in an unfragmented state.

Similarly, each other device in the N devices has fragmented data included in the device. As the diffusion operation continues, fragmented edges are gradually added to the fragmented data until all edges of the knowledge graph are respectively added to the fragmented data of the N devices.

In step S250, first device A obtains an end node included in a fragmented edge in fragmented data of another device as a fragmented node of the other device. The other device refers to a device different from first device A in the N devices.

First device A can individually send an obtaining request to another device to obtain a fragmented node of the other device. When receiving the obtaining request of first device A, the other device determines the fragmented node from the fragmented data of the other device, and sends the fragmented node to first device A. The fragmented node of the other device obtained by first device A can be understood an obtained quantity of fragmented nodes of the other device.

First device A can further receive an obtaining request sent by another device, where the obtaining request is used to obtain the fragmented node of first device A. First device A can send the fragmented node of first device A to the other device, so that the other device adjusts a diffusion velocity of the other device based on the fragmented node of first device A. All the fragmented nodes exchanged between devices can be quantities of fragmented nodes.

In step S260, first device A adjusts the first diffusion velocity Vₑ based on comparison between a fragmented node of first device A and the fragmented node of the other device.

When it is determined, based on comparison between a quantity N_{A}^{v} of fragmented nodes of first device A and a quantity of fragmented nodes of the other device, that a node fragmentation progress of first device A is greater than a first predetermined progress, it indicates that the node fragmentation progress of first device A is excessively fast, and the first diffusion velocity Vₑ can be decreased by using a first correction factor Dᵥ. When it is determined that the node fragmentation progress of first device A is not greater than the first predetermined progress, the first diffusion velocity Vₑ can remain unchanged.

Specifically, first device A can determine, in the following way, that the node fragmentation progress of first device A is greater than the first predetermined progress:
determining that the node fragmentation progress of first device A is greater than the first predetermined progress when the quantity N_{A}^{v} of fragmented nodes of first device A is greater than an average quantity N_{avg}^{v} of fragmented nodes of the plurality of devices, and a node balance degree M_{A}^{v} of first device A is greater than a predetermined node balance degree Bᵥ.

The predetermined node balance degree Bᵥ can be a threshold set in advance based on experience. Both the average quantity N_{avg}^{v} of fragmented nodes and the node balance degree M_{A}^{v} of first device A are determined based on quantities of fragmented nodes of the plurality of devices. The average quantity N_{avg}^{v} of fragmented nodes is an average value of the quantities of fragmented nodes of the plurality of devices. The node balance degree M_{A}^{v} of first device A can be calculated according to the following formula (1):

$${M}_{A}^{v} = \frac{{N}_{A}^{v}}{min ( {N}_{i}^{v} )} \qquad ( 1 )$$

Nᵢ^{v} is a quantity of fragmented nodes of an i^{th} device, min(Nᵢ^{v}) is a minimum value of the quantity of fragmented nodes of the i^{th} device, and a superscript V of the parameter represents that the parameter is related to the node. The node balance degree of first device A represents a value of a balance degree of the fragmented nodes of first device A in the fragmented nodes of the plurality of devices.

The node balance degree can be further determined by using another formula. For example, the node balance degree is determined by using a difference between the quantity N_{A}^{v} of fragmented nodes and the average quantity N_{avg}^{v} of fragmented nodes, for example, can be determined by using a ratio of the difference to the average quantity N_{avg}^{v} of fragmented nodes.

In addition, the quantity of fragmented nodes is compared with the average value, and the node balance degree is compared with the threshold. When the quantity of fragmented nodes is greater than the average value, and the node balance degree is greater than the threshold, it is determined that the node fragmentation progress of first device A is greater than the first predetermined progress. Through the foregoing two comparisons, a device whose quantity of fragmented nodes is slightly greater than the average value, but whose node balance degree is not greater than the threshold can be ruled out, and a diffusion velocity of such a device does not need to be decreased. In the one or more embodiments, the first predetermined progress is not a specific value, but a complex special state, and is an advanced diffusion state of first device A relative to another device.

When it is determined, based on comparison between the quantity N_{A}^{v} of fragmented nodes of first device A and the quantity of fragmented nodes of the other device, that the node fragmentation progress of first device A is less than a second predetermined progress, it indicates that the node fragmentation progress of first device A is excessively slow, and the first diffusion velocity Vₑ can be increased by using the first correction factor Dᵥ. When it is determined that the node fragmentation progress of first device A is not less than the second predetermined progress, the first diffusion velocity Vₑ can remain unchanged.

Specifically, first device A can determine, in the following way, that the node fragmentation progress of first device A is less than the second predetermined progress:

determining that the node fragmentation progress of first device A is less than the second predetermined progress when the quantity N_{A}^{v} of fragmented nodes of first device A is not greater than the average quantity N_{avg}^{v} of fragmented nodes, and a maximum node balance degree max(Mᵢ^{v}) in the plurality of devices is greater than the predetermined node balance degree Bᵥ. When the quantity of fragmented nodes is greater than the average value, and the maximum node balance degree is greater than the threshold, it indicates that not only the quantity of fragmented nodes of first device A is less than the average value, but also the maximum node balance degree is greater than the threshold, and a node balance degree of a device is already advanced. In this case, there is no need to compare the node balance degree of first device A with the threshold value, because the node balance degree of first device A is generally relatively small.

In the one or more embodiments, the second predetermined progress is not a specific value, but a complex special state, and is a lagged diffusion state of first device A relative to another device. The second predetermined progress is less than the first predetermined progress.

The following further describes in detail how to adjust the first diffusion velocity Vₑ when it is determined that the node fragmentation progress of first device A is greater than the first predetermined progress. In an implementation, the first diffusion velocity can be temporarily set to 0, that is, first device A enters a waiting state. When it is determined that the node fragmentation progress of first device A is not greater than the first predetermined progress, to increase a fragmentation speed of the device, the first diffusion velocity Vₑ can be decreased by using the first correction factor Dᵥ when it is determined that the node fragmentation progress of first device A is greater than the first predetermined progress. When it is determined that the node fragmentation progress of first device A is less than the second predetermined progress, the first diffusion velocity Vₑ is increased by using the first correction factor Dᵥ.

In an implementation, the first diffusion velocity Vₑ can be decreased by subtracting Dᵥ from the first diffusion velocity Vₑ, and the first diffusion velocity Vₑ is increased by adding Dᵥ to the first diffusion velocity Vₑ. In this implementation, a change of the first diffusion velocity Vₑ depends on setting of Dᵥ. When Dᵥ is set to be relatively small, a convergence speed of the node balance degree is relatively small; and when Dᵥ is set to be large, the convergence speed of the node balance degree is relatively large. Dᵥ can be a predetermined constant, or can be adjusted as an iteration process proceeds, for example, Dᵥ gradually decreases as a quantity of iterations increases.

In some knowledge graphs, distribution of degrees of nodes in the knowledge graphs is approximately power law distribution, that is, nodes with small degrees usually account for a very large proportion, while nodes with large degrees account for a very small proportion. It is found through the applicant's research that, quantities of nodes with different degrees are exponentially related to degrees of the nodes. When 0.1 is added to Vₑ, that is, Dᵥ is 0.1, a quantity of diffused edges is not increased by 10%, but by (e^{0.1}−1)*100%=10.52%; and when 0.3 is added to Vₑ, an increase amplitude is 34.99%. Conversely, when 0.1 is subtracted from Vₑ, the quantity of diffused edges is decreased by about 9.52%; and when 0.3 is subtracted from Vₑ, a decrease amplitude is about 25.92%. Therefore, decreasing a diffusion velocity of a device whose node has a relatively large degree by 0.1 (or 0.3) and increasing a diffusion velocity of a device whose node has a relatively small degree by 0.1 (or 0.3) have different influences a quantity of edges during diffusion.

To make an adjusted speed of the diffusion velocity more proper to make execution of the data fragmentation process more controllable, the first diffusion velocity Vₑ can be decreased according to a logarithmic rule of the first correction factor Dᵥ; or the first diffusion velocity Vₑ is increased according to the logarithmic rule of the first correction factor Dᵥ.

In an implementation, first device A can decrease the first diffusion velocity Vₑ according to the following formula (2):

$${V}_{e}^{2} = {V}_{e}^{1} * [ 1 - {log}_{a} ( 1 + {D}_{v} ) ] \qquad ( 2 )$$

First device A can increase the first diffusion velocity Vₑ according to the following formula (3):

$${V}_{e}^{2} = {V}_{e}^{1} * [ 1 + {log}_{a} ( 1 + {D}_{v} ) ] \qquad ( 3 )$$

Vₑ² is an adjusted first diffusion velocity, Vₑ¹ is the first diffusion velocity before the adjustment, and logₐ is a logarithm with a base a, where a can be a predetermined value, for example, can be a natural constant e. The foregoing formulas (2) and (3) are merely implementations in which the first diffusion velocity Vₑ is adjusted according to the logarithmic rule of the first correction factor Dᵥ. Based on these formulas, implementations in other forms are easily obtained, for example, multiplying a coefficient or dividing by a coefficient.

In the one or more embodiments, the first diffusion velocity is adjusted according to the logarithmic rule of the first correction factor Dᵥ. For devices in which degrees of nodes are excessively large or excessively small, a decrease amplitude and an increase amplitude of the diffusion velocity of the device are basically the same. In addition, a setting range of Dᵥ can be more relaxed, and an overall convergence speed is also relatively large.

In an implementation scenario, the knowledge graph can include a super hotspot. A quantity of edges (that is, a degree) associated with the super hotspot is huge, which is far greater than a quantity of edges associated with another node. When the super hotspot exists in a part of edges of a certain device, and the super hotspot is selected as an initial boundary point or a diffusion node used during the first several times of diffusion, a quantity of target edges determined near the super hotspot can quickly reach a relatively large value, so that a quantity of fragmented nodes reaches a very large value. In addition, as the data fragmentation process proceeds, data distribution in different devices can also be different in different iterative steps.

To make the adjustment to the first diffusion velocity Vₑ more proper, and avoid a relatively large deviation between data fragmentation processes of the plurality of devices, the first correction factor Dᵥ can be adaptively adjusted in the one or more embodiments. For example, the first correction factor Dᵥ can be determined based on comparison between the quantity N_{A}^{v} of fragmented nodes of first device A and the average quantity N_{avg}^{v} of fragmented nodes of the plurality of devices.

In an implementation, first device A can decrease the first diffusion velocity Vₑ according to the following formula (4):

$${V}_{e}^{2} = {V}_{e}^{1} * \{ 1 - {log}_{a} [ 1 + {D}_{v} * {log}_{b} ( b + \frac{{N}_{A}^{v} - {N}_{avg}^{v}}{{N}_{avg}^{v}} ) ] \} \qquad ( 4 )$$

First device A can increase the first diffusion velocity Vₑ according to the following formula (5):

$${V}_{e}^{2} = {V}_{e}^{1} * \{ 1 + {log}_{a} [ 1 + {D}_{v} * {log}_{b} ( b + \frac{{N}_{avg}^{v} - {N}_{A}^{v}}{{N}_{A}^{v}} ) ] \} \qquad ( 5 )$$

Vₑ² is an adjusted first diffusion velocity, Vₑ¹ is the first diffusion velocity before the adjustment, and log_{b} is a logarithm with a base b, where b can be a predetermined value, for example, can be a natural constant e, and values of a and b can be the same or can be different. N_{A}^{v} is the quantity of fragmented nodes of first device A, and N_{avg}^{v} is the average quantity of fragmented nodes. It can be seen from the formulas (4) and (5) that, the first correction factor Dᵥ is multiplied by a logarithmic correction term in the parenthesis, and the logarithmic correction term is related to comparison between the quantity N_{A}^{v} of fragmented nodes of first device A and the average quantity N_{avg}^{v} of fragmented nodes of the plurality of devices. The logarithmic correction term and the correction way are merely an implementation. Based on these formulas, implementations in other forms can be easily obtained. For example, it is also a feasible implementation to directly modifying the first correction factor Dᵥ to the following forms:

$${D}_{v} * {log}_{b} [ b + γ \cdot \frac{{N}_{A}^{v} - {N}_{avg}^{v}}{{N}_{avg}^{v}} ] or {D}_{v} * {log}_{b} [ b + γ \cdot \frac{{N}_{avg}^{v} - {N}_{A}^{v}}{{N}_{A}^{v}} ]$$

where γ is a predetermined coefficient.

In step S270, first device A continues to select a diffusion node based on an adjusted first diffusion velocity Vₑ, and returns to perform step S230, that is, to obtain an edge that is in the knowledge graph and that uses the diffusion node as an end node on one side.

When continuing to select the diffusion node, first device A can select the diffusion node from end nodes on the other side of the target edge in step S240 based on the adjusted first diffusion velocity Vₑ. The diffusion node in step S230 is an end node on one side of the target edge, and the end node on the other side of the target edge is an end node different from the end node on one side mentioned in step S230. Selecting the diffusion node from the end nodes on the other side of the target edge is diffusing towards a direction of a neighboring neighbor direction based on a direction pointed by the target edge.

When first device A selects the diffusion node from the end node on the other side of the target edge based on the adjusted first diffusion velocity Vₑ, 1b to 3b can be included.

Step 1b: Select a first quantity of nodes from the end nodes on the other side of the target edge as boundary points to obtain a plurality of boundary points. For description of this step, references can be made to step 1a. Details are omitted here for simplicity.

Step 2b: Sort the plurality of boundary points in ascending order of quantities of edges associated with the boundary points.

The quantity of edges associated with the boundary point, that is, the degree, can be determined in the way of determining the initial boundary point in step 2a, and Details are omitted here for simplicity.

Step 3b: Select the diffusion node from a plurality of sorted boundary points based on the adjusted first diffusion velocity Vₑ. During selection, selection can be performed starting from a start location in a sorted sequence to select a boundary point with a relatively small degree as the diffusion node based on the value of the adjusted first diffusion velocity Vₑ.

The foregoing steps S220 to S240 can be understood as a fragmentation iteration process (or referred to as a diffusion iteration process). Steps S250 and S260 is a process of adjusting the first diffusion velocity. In actual application, one process of adjusting the first diffusion velocity can be performed after each fragmentation iteration process, or a process of adjusting the first diffusion velocity can be performed after a plurality of fragmentation iteration processes are performed. When a plurality of fragmentation iteration processes are performed, after the target edge is added to the first fragmented data in step S240, the diffusion node can continue to be selected from the end nodes on the other side of the target edge based on the first diffusion velocity Vₑ, and return to perform step S230.

In step S230, when obtaining the edge that is in the knowledge graph and that uses the diffusion node as an end node on one side, first device A can further determine whether a quantity of to-be-fragmented edges is greater than a predetermined threshold. If the quantity is greater than the predetermined threshold, it indicates that the quantity of the to-be-fragmented edge is sufficient; or if the quantity is not greater than the predetermined threshold, first device A can select a diffusion node from an unselected node in the first part of edges based on the first diffusion velocity Vₑ in a next fragmentation iteration process. When all the edges in the knowledge graph are respectively added to the fragmented data of the plurality of devices, it is considered that the data fragmentation process is completed, and the iteration process shown in FIG. 2 ends.

The one or more embodiments in FIG. 2 merely shows a core idea of a feasible implementation. In actual application, a plurality of specific operation ways can be selected. In the one or more embodiments shown in FIG. 2, initially, random average division is performed on the knowledge graph for the edges, and a part of edges are respectively stored in the plurality of devices. In the data fragmentation process, the diffusion node is selected based on the first diffusion velocity, which reflects balancing processing on the edges. The first diffusion velocity is adjusted by comparing the quantities of fragmented nodes of the plurality of devices, so that balancing processing is implemented on the nodes in addition to balancing processing on the edges.

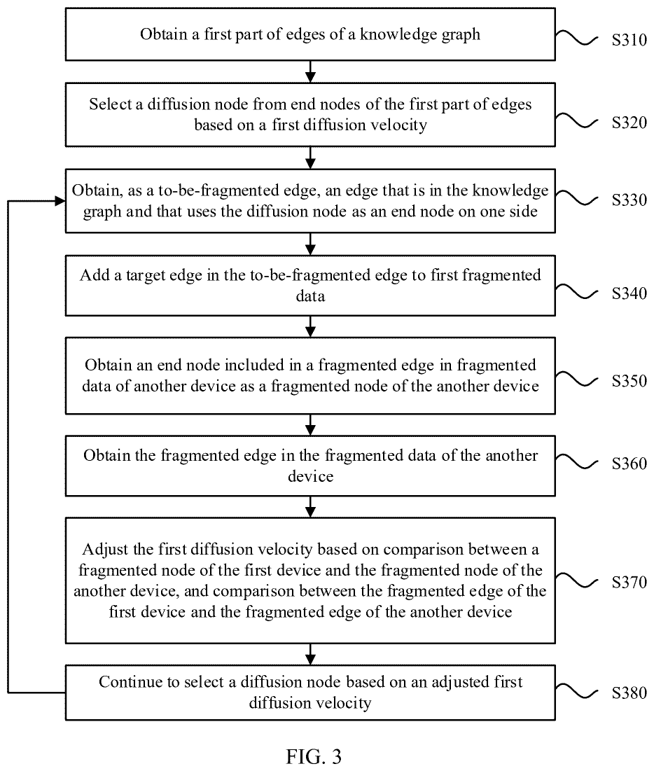

In other embodiments of this specification, more proper balancing processing can be further performed on the edges. The one or more embodiments shown in FIG. 2 can be improved to obtain one or more embodiments shown in FIG. 3. FIG. 3 is a schematic flowchart illustrating another method for performing data fragmentation on a knowledge graph, according to one or more embodiments. The one or more embodiments in FIG. 3 include steps S310 to S370. Steps S310 to S350 and step S380 are respectively the same as steps S210 to S250 and step S270 in the one or more embodiments in FIG. 2, and details are omitted for simplicity in the one or more embodiments. In the following descriptions for the one or more embodiments shown in FIG. 3, a difference from the one or more embodiments shown in FIG. 2 is emphatically described. For the same part, references can be made to the descriptions of the one or more embodiments shown in FIG. 2. Details are omitted for simplicity in the one or more embodiments.

Step S360: Before adjusting the first diffusion velocity Vₑ, first device A obtains a fragmented edge in fragmented data of another device. Step S360 can be performed before, after, or simultaneously with step S350.

First device A can individually send an obtaining request to another device to obtain a fragmented edge of the other device. When receiving the obtaining request of first device A, the other device determines the fragmented edge from fragmented data of the other device, and sends the fragmented edge to first device A. The fragmented edge of the other device obtained by first device A can be understood an obtained quantity of fragmented edges of the other device.

First device A can further receive an obtaining request sent by another device, where the obtaining request is used to obtain the fragmented edge of first device A. First device A can send the fragmented edge of first device A to the other device, so that the other device adjusts a diffusion velocity of the other device based on the fragmented edge of first device A. All the fragmented edges exchanged between devices can be quantities of fragmented edges.

Step S370: First device A adjusts the first diffusion velocity Vₑ based on comparison between the fragmented node of first device A and a fragmented node of the other device, and comparison between the fragmented edge of first device A and the fragmented edge of the other device. This step can include the following steps 1c and 2c when being performed.

Step 1c: First device A preliminarily adjusts the first diffusion velocity Vₑ based on comparison between the fragmented node of first device A and the fragmented node of the other device.

Step 2c: First device A continues to adjust the adjusted first diffusion velocity Vₑ based on comparison between the fragmented edge of first device A and the fragmented edge of the other device.

The first diffusion velocity Vₑ can be first adjusted based on comparison between fragmented edges, and then adjusted based on comparison between fragmented nodes. The following merely uses a shown sequence of steps 1c and 2c as an example to describe in detail a process of adjusting the first diffusion velocity Vₑ in the one or more embodiments.

An execution process of step 1c can be completely the same as an execution process of step S260. For specific descriptions, references can be made to the descriptions in the one or more embodiments shown in FIG. 2. Details are omitted here for simplicity. The following emphatically describes step 2c.

When it is determined, based on comparison between a quantity N_{A}^{e} of fragmented edges of first device A and a quantity of fragmented edges of the other device, that an edge fragmentation progress of first device A is greater than a third predetermined progress, it indicates that the edge fragmentation progress of first device A is excessively fast, and the first diffusion velocity Vₑ can be decreased by using a second correction factor Dₑ. When it is determined that the edge fragmentation progress of first device A is not greater than the third predetermined progress, the first diffusion velocity Vₑ can remain unchanged and step S380 continue to be performed.

Specifically, first device A can determine, in the following way, that the edge fragmentation progress of first device A is greater than the third predetermined progress:
determining that the edge fragmentation progress of first device A is greater than the third predetermined progress when the quantity N_{A}^{e} of fragmented edges of first device A is greater than an average quantity N_{avg}^{e} of fragmented nodes of the plurality of devices, and an edge balance degree M_{A}^{e} of first device A is greater than a predetermined edge balance degree Bₑ.

The predetermined edge balance degree Bₑ can be a threshold set in advance based on experience. Both the average quantity N_{avg}^{e} of fragmented edges and the edge balance degree M_{A}^{e} are determined based on quantities of fragmented edges of the plurality of devices. The average quantity N_{avg}^{e} of fragmented edges is an average value of the quantities of fragmented edges of the plurality of devices. The edge balance degree M_{A}^{e} of first device A can be calculated according to the formula (6):

$${M}_{A}^{e} = \frac{{N}_{A}^{e}}{min ( {N}_{i}^{e} )} \qquad ( 6 )$$

Nᵢ^{e} is a quantity of fragmented edges of an i^{th} device, min(Nᵢ^{e}) is a minimum value of the quantity of fragmented edges of the i^{th} device, and a superscript e of the parameter represents that the parameter is related to the edge. The edge balance degree of first device A represents a value of a balance degree of the fragmented edges of first device A in the fragmented edges of the plurality of devices.

The edge balance degree can be further determined by using another formula. For example, the edge balance degree is determined by using a difference between the quantity N_{A}^{e} of fragmented edges and the average quantity N_{avg}^{e} of fragmented edges, for example, can be determined by using a ratio of the difference to the average quantity N_{avg}^{e} of fragmented edges.

In addition, the quantity of fragmented edges is compared with the average value, and the edge balance degree is compared with the threshold. When the quantity of fragmented edges is greater than the average value, and the edge balance degree is greater than the threshold, it is determined that the edge fragmentation progress of first device A is greater than the third predetermined progress. Through the foregoing two comparisons, a device whose quantity of fragmented edges is slightly greater than the average value, but whose edge balance degree is not greater than the threshold can be ruled out, and a diffusion velocity of such a device does not need to be decreased due to the edges. In the one or more embodiments, the third predetermined progress is not a specific value, but a complex special state, and is an advanced diffusion state of first device A relative to another device.

When it is determined, based on comparison between the quantity N_{A}^{e} of fragmented edges of first device A and the quantity of fragmented edges of the other device, that the edge fragmentation progress of first device A is less than a fourth predetermined progress, it indicates that the edge fragmentation progress of first device A is excessively slow, and the first diffusion velocity Vₑ can be increased by using the second correction factor Dₑ. When it is determined that the edge fragmentation progress of first device A is not less than the fourth predetermined progress, an adjusted first diffusion velocity Vₑ can remain unchanged.

Specifically, first device A can determine, in the following way, that the edge fragmentation progress of first device A is less than the fourth predetermined progress:
determining that the edge fragmentation progress of first device A is less than the fourth predetermined progress when the quantity N_{A}^{v} of fragmented edges of first device A is not greater than the average quantity N_{avg}^{e} of fragmented edges, and a maximum edge balance degree max(Mᵢ^{e}) in the plurality of devices is greater than the predetermined edge balance degree Bₑ. When the quantity of fragmented edges is greater than the average value, and the maximum edge balance degree is greater than the threshold, it indicates that not only the quantity of fragmented edges of first device A is less than the average value, but also the maximum edge balance degree is greater than the threshold, and an edge balance degree of a device is already advanced. In this case, there is no need to compare the edge balance degree of first device A with the threshold value, because the edge balance degree of first device A is generally relatively small.

In the one or more embodiments, the fourth predetermined progress is not a specific value, but a complex special state, and is a lagged diffusion state of first device A relative to another device. The fourth predetermined progress is less than the third predetermined progress.

The following further describes in detail how to adjust the adjusted first diffusion velocity Vₑ when it is determined that the edge fragmentation progress of first device A is greater than the third predetermined progress. To increase an edge fragmentation speed of the device, the adjusted first diffusion velocity Vₑ can be decreased by using the second correction factor Dₑ when it is determined that the edge fragmentation progress of first device A is greater than the third predetermined progress. When it is determined that the edge fragmentation progress of first device A is less than the fourth predetermined progress, the adjusted first diffusion velocity Vₑ is increased by using the second correction factor Dₑ.

In an implementation, the adjusted first diffusion velocity Vₑ can be decreased by subtracting Dₑ from the adjusted first diffusion velocity Vₑ, and the adjusted first diffusion velocity Vₑ is increased by adding Dₑ to the adjusted first diffusion velocity Vₑ. In this implementation, a change of the first diffusion velocity Vₑ depends on setting of Dₑ. When Dₑ is set to be relatively small, a convergence speed of the edge balance degree is relatively small; and when Dₑ is set to be large, the convergence speed of the edge balance degree is relatively large. Dₑ can be a predetermined constant, or can be adjusted as an iteration process proceeds, for example, Dₑ gradually decreases as a quantity of iterations increases.

To make an adjusted speed of the diffusion velocity more proper to make execution of the data fragmentation process more controllable, the adjusted first diffusion velocity Vₑ can be decreased according to a logarithmic rule of the second correction factor Dₑ.

In an implementation, first device A can decrease the adjusted first diffusion velocity Vₑ according to the following formula (7):

$${V}_{e}^{3} = {V}_{e}^{2} * [ 1 - {log}_{a} ( 1 + {D}_{e} ) ] \qquad ( 7 )$$

First device A can increase the adjusted first diffusion velocity Vₑ according to the following formula (8):

$${V}_{e}^{3} = {V}_{e}^{2} * [ 1 + {log}_{a} ( 1 + {D}_{e} ) ] \qquad ( 8 )$$

Vₑ² is the adjusted first diffusion velocity, Vₑ³ is a diffusion velocity obtained after the adjusted first diffusion velocity continues to be adjusted by using the second correction factor Dₑ, and logₐ is a logarithm with a base a, where a can be a predetermined value, for example, can be a natural constant e. The foregoing formulas (7) and (8) are merely implementations in which the adjusted first diffusion velocity Vₑ² continues to be adjusted according to the logarithmic rule of the second correction factor Dₑ. Based on these formulas, implementations in other forms are easily obtained, for example, multiplying a coefficient or dividing by a coefficient.

In the one or more embodiments, the adjusted first diffusion velocity is adjusted according to the logarithmic rule of the second correction factor Dₑ. For devices in which degrees of nodes are excessively large or excessively small, decrease amplitudes and increase amplitudes of the diffusion velocity of the device are basically the same. In addition, a setting range of Dₑ can be more relaxed, and an overall convergence speed is also relatively large.

To make the adjustment to the adjusted first diffusion velocity Vₑ more proper, and avoid a relatively large deviation between data fragmentation processes of the plurality of devices, the second correction factor Dₑ can be adaptively adjusted in the one or more embodiments. For example, the second correction factor Dₑ can be determined based on comparison between the quantity N_{A}^{e} of fragmented edges of first device A and the average quantity N_{avg}^{e} of fragmented edges of the plurality of devices.

In an implementation, first device A can decrease the adjusted first diffusion velocity according to the following formula (9):

$${V}_{e}^{3} = {V}_{e}^{2} * \{ 1 - {log}_{a} [ 1 + {D}_{e} * {log}_{b} ( b + \frac{{N}_{A}^{e} - {N}_{avg}^{e}}{{N}_{avg}^{e}} ) ] \} \qquad ( 9 )$$

First device A can increase the adjusted first diffusion velocity according to the following formula (10):

$${V}_{e}^{3} = {V}_{e}^{2} * \{ 1 + {log}_{a} [ 1 + {D}_{e} * {log}_{b} ( b + \frac{{N}_{avg}^{e} - {N}_{A}^{e}}{{N}_{A}^{e}} ) ] \} \qquad ( 10 )$$

Vₑ² is the adjusted first diffusion velocity, Vₑ³ is a diffusion velocity obtained after the adjusted first diffusion velocity continues to be adjusted by using the second correction factor Dₑ, and log_{b} is a logarithm with a base b, where b can be a predetermined value, for example, can be a natural constant e, and values of a and b can be the same or can be different. N_{A}^{e} is the quantity of fragmented edges of first device A, and N_{avg}^{e} is the average quantity of fragmented edges. It can be seen from the formulas (9) and (10) that, the second correction factor Dₑ is multiplied by a logarithmic correction term, and the logarithmic correction term is related to comparison between the quantity N_{A}^{e} of fragmented edges of first device A and the average quantity N_{avg}^{e} of fragmented edges. The logarithmic correction term and the correction way are merely an implementation. Based on these formulas, implementations in other forms can be easily obtained. For example, it is also a feasible implementation to directly modifying the second correction factor Dₑ to the following forms:

$${D}_{e} * {log}_{b} ( b + γ \cdot \frac{{N}_{A}^{e} - {N}_{avg}^{e}}{{N}_{avg}^{e}} ) or {D}_{e} * {log}_{b} ( b + γ \cdot \frac{{N}_{avg}^{e} - {N}_{A}^{e}}{{N}_{A}^{e}} )$$

where γ is a predetermined coefficient.

In an implementation, the adjustment to the first diffusion velocity Vₑ can be further combined with a quantity S of iterations. For example, initial Vₑ can be set to 0.1. When the quantity S of iterations ranges from 0 to S_{f}, it indicates a fine iterative fragmentation phase, and the adjustment to the first diffusion velocity Vₑ can start by using the initial Vₑ taking 0.1. For example, S_{f} can be 500. When the quantity of iterations is greater than S_{f} and less than S_{c}, it indicates a coarse iterative fragmentation phase, where S_{c} can be a value greater than 500, for example, can be 1000. The adjustment to the first diffusion velocity Vₑ can include formula (11):

$${V}_{e}^{1} = {V}_{e}^{0} + ( 1 - {V}_{e}^{0} ) * \frac{S - {S}_{f}}{{S}_{C} - {S}_{f}} \qquad ( 11 )$$

Vₑ⁰ is a first diffusion velocity before the adjustment, Vₑ¹ is a first diffusion velocity adjusted by using the quantity of iterations, and S is the quantity of iterations, which gradually increases with the iteration process. S_{f} and S_{c} are predetermined values. The adjustment to the first diffusion velocity in formula (11) can be combined with the adjustment to the first diffusion velocity based on based on comparison between quantities of fragmented nodes and the adjustment to the first diffusion velocity based on comparison between quantities of fragmented edges. For example, formula (11) is combined with “one of formula (4) and formula (5)” and “one of formula (9) and formula (10)”.

In the foregoing embodiments, because the diffusion velocity is merely a quantity proportion, when data such as edges and nodes of different devices have different characteristics, diffusion nodes selected by using the diffusion velocity and quantities of target edges obtained by using the diffusion velocity are different either. As a result, quantities of nodes in fragmented data of different devices are unbalanced, or quantities of edges are unbalanced. In the foregoing embodiments, the diffusion velocity is adjusted to balance quantities of nodes of the fragmented data of the plurality devices balanced, and balance quantities of edges, thereby balancing the fragmented data in the plurality of devices. Load balancing can be achieved when the fragmented data in the plurality of devices is queried.

In this specification, “first” in words such as the first part of edges, the first device, the first diffusion velocity, the first fragmented data, the first predetermined progress, and the first quantity, and a corresponding “second” in this specification are merely intended to facilitate distinguishing and description, and have no limitation meaning.

Some specific embodiments of this specification have been described above, and other embodiments fall within the scope of the appended specification. In some cases, actions or steps described in this specification can be performed in a sequence different from that in the embodiments and desired results can still be achieved. In addition, processes described in the accompanying drawings do not necessarily need a specific order or a sequential order shown to achieve the desired results. In some implementations, multitasking and parallel processing are also feasible or may be advantageous.

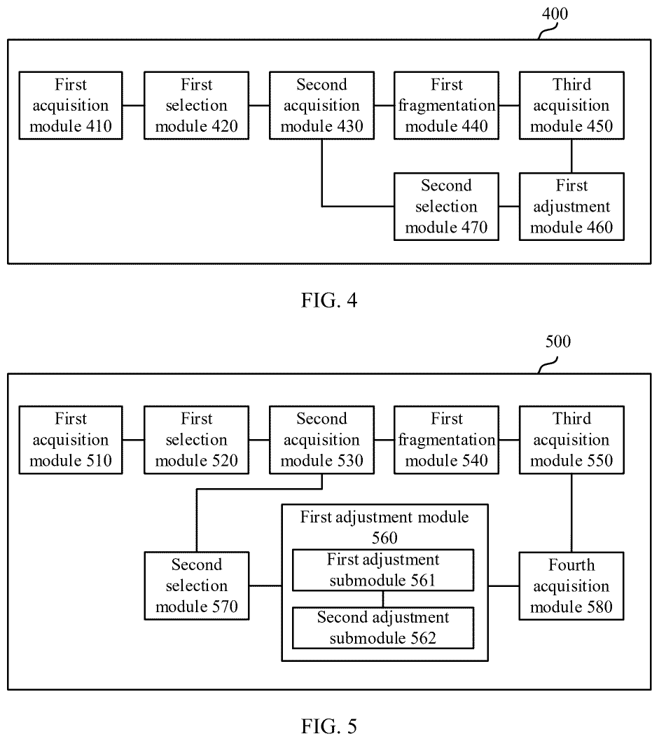

FIG. 4 is a schematic block diagram illustrating an apparatus for performing data fragmentation on a knowledge graph, according to one or more embodiments. The apparatus 400 is configured to split a knowledge graph into a plurality of pieces of data, and the plurality of pieces of data are included in a plurality of devices. Any device can be implemented by any apparatus, device, platform, device cluster, etc. having a computing and processing capability. The knowledge graph includes a plurality of nodes representing entities and edges representing relations between the nodes. This apparatus embodiment corresponds to the method embodiment shown in FIG. 2. The apparatus 400 is deployed in any first device in the plurality of devices and includes:
a first acquisition module 410, configured to obtain a first part of edges of the knowledge graph, where the first part of edges are obtained after initial splitting is performed on a plurality of edges of the knowledge graph; a first selection module 420, configured to select a diffusion node from end nodes of the first part of edges based on a first diffusion velocity; a second acquisition module 430, configured to obtain, as a to-be-fragmented edge, an edge that is in the knowledge graph and that uses the diffusion node as an end node on one side; a first fragmentation module 440, configured to add a target edge in the to-be-fragmented edge to first fragmented data, where the first fragmented data is included in the first device, and the first fragmented data includes a fragmented edge; a third acquisition module 450, configured to obtain an end node included in a fragmented edge in fragmented data of another device as a fragmented node of the other device; a first adjustment module 460, configured to adjust the first diffusion velocity based on comparison between a fragmented node of the first device and the fragmented node of the other device; and a second selection module 470, configured to continue to select a diffusion node based on an adjusted first diffusion velocity, and return to perform the second acquisition module 430, that is, obtain an edge that is in the knowledge graph and that uses the diffusion node as an end node on one side.

In an implementation, a value of the first diffusion velocity is between (0, 1], and is used to represent a selected quantity proportion.

In an implementation, the first selection module 420 is specifically configured to select a first quantity of nodes from the end nodes of the first part of edges as initial boundary points; sort the plurality of initial boundary points in ascending order of quantities of edges associated with the initial boundary points; and select the diffusion node from a plurality of sorted initial boundary points based on the first diffusion velocity.

In an implementation, the apparatus 400 further includes: a first determining module (not shown in the figure), configured to determine the quantity of edges associated with the initial boundary point by using the following operations: obtaining an edge that is in another device and that uses the initial boundary point as an end node on one side, where the other device includes a device different from the first device in the plurality of devices, and the obtained edge is determined by the other device from a part of edges owned by the other device; and determining, for any initial boundary point, the quantity of edges associated with the initial boundary point based on a sum of a quantity of edges that are in the first part of edges and that use the initial boundary point as an end node on one side and a quantity of edges that are in the other device and that use the initial boundary point as an end node on one side.

In an implementation, the second acquisition module 430 is specifically configured to obtain an edge that uses the diffusion node as an end node on one side from a part of edges owned by another device; and determine, as the edge that is in the knowledge graph and that uses the diffusion node as an end node on one side, an edge that is in the obtained edge and the first part of edges and that uses the diffusion node as an end node on one side.

In an implementation, the apparatus 400 further includes a third selection module (not shown in the figure), configured to: before the target edge in the to-be-fragmented edge is added to the first fragmented data, select the target edge from the to-be-fragmented edge based on the first diffusion velocity to determine the target edge from the to-be-fragmented edge.

In an implementation, the apparatus 400 further includes: a first receiving module (not shown in the figure), configured to receive an obtaining request sent by another device, where the obtaining request is used to obtain a fragmented node of the first device; and a first sending module (not shown in the figure), configured to send the fragmented node of the first device to the other device, so that the other device adjusts a diffusion velocity of the other device based on the fragmented node of the first device.

In an implementation, the second selection module 470 is specifically configured to select the diffusion node from an end node on the other side of the target edge based on the adjusted first diffusion velocity.

Alternatively, the second selection module 470 is specifically configured to select the diffusion node from an unselected end node in the first part of edges based on the adjusted first diffusion velocity.

In an implementation, the first adjustment module 460 is specifically configured to decrease the first diffusion velocity by using a first correction factor when it is determined, based on comparison between a quantity of fragmented nodes of the first device and a quantity of fragmented nodes of the other device, that a node fragmentation progress of the first device is greater than a first predetermined progress.

In an implementation, when the first adjustment module 460 decreases the first diffusion velocity by using the first correction factor, the following operation is included: decreasing the first diffusion velocity according to a logarithmic rule of the first correction factor.

In an implementation, the apparatus 400 further includes a second determining module (not shown in the figure), configured to determine that the node fragmentation progress of the first device is greater than the first predetermined progress when the quantity of fragmented nodes of the first device is greater than an average quantity of fragmented nodes of the plurality of devices, and a node balance degree of the first device is greater than a predetermined node balance degree, where the average quantity of fragmented nodes and the node balance degree are determined based on quantities of fragmented nodes of the plurality of devices.

In an implementation, the first adjustment module 460 is further configured to increase the first diffusion velocity by using the first correction factor when it is determined, based on comparison between the quantity of fragmented nodes of the first device and the quantity of fragmented nodes of the other device, that the node fragmentation progress of the first device is less than a second predetermined progress.

In an implementation, the apparatus 400 further includes: a third determining module (not shown in the figure), configured to determine that the node fragmentation progress of the first device is less than the second predetermined progress when the quantity of fragmented nodes of the first device is not greater than an average quantity of fragmented nodes, and a maximum node balance degree in the plurality of devices is greater than a predetermined node balance degree.

In an implementation, the first correction factor is determined based on comparison between the quantity of fragmented nodes of the first device and an average quantity of fragmented nodes of the plurality of devices.

In other embodiments of this specification, the one or more embodiments shown in FIG. 4 can be improved to obtain one or more embodiments shown in FIG. 5. FIG. 5 is a schematic block diagram illustrating another apparatus embodiment, according to one or more embodiments. This apparatus embodiment corresponds to the method embodiment shown in FIG. 3. The apparatus 500 includes a first acquisition module 510, a first selection module 520, a second acquisition module 530, a first fragmentation module 540, a third acquisition module 550, a fourth acquisition module 580, a first adjustment module 560, and a second selection module 570.

The first acquisition module 510, the first selection module 520, the second acquisition module 530, the first fragmentation module 540, the third acquisition module 550, and the second selection module 570 are respectively completely the same as the first acquisition module 410, the first selection module 420, the second acquisition module 430, the first fragmentation module 440, the third acquisition module 450, and the second selection module 470 in the embodiment shown in FIG. 4. These modules are not described in detail in the one or more embodiments. The following focuses on differences from the one or more embodiments in FIG. 4.

A fourth acquisition module 580 is configured to obtain a fragmented edge in fragmented data of another device before the first diffusion velocity is adjusted. A first adjustment module 560 is configured to adjust the first diffusion velocity based on comparison between the fragmented node of the first device and a fragmented node of the other device, and comparison between the fragmented edge of the first device and the fragmented edge of the other device.

In an implementation, the first adjustment module 560 can include: a first adjustment submodule 561, configured to preliminarily adjust the first diffusion velocity based on comparison between the fragmented node of the first device and the fragmented node of the other device; and a second adjustment submodule 562, configured to continue to adjust the adjusted first diffusion velocity based on comparison between the fragmented edge of the first device and the fragmented edge of the other device.

In an implementation, the second adjustment submodule 562 is specifically configured to decrease the adjusted first diffusion velocity by using a second correction factor when it is determined, based on comparison between a quantity of fragmented edges of the first device and a quantity of fragmented edges of the other device, that an edge fragmentation progress of the first device is greater than a third predetermined progress.

In an implementation, the second adjustment submodule 562 is specifically configured to decrease the adjusted first diffusion velocity according to a logarithmic rule of the second correction factor.

In an implementation, the first adjustment module 560 further includes: a first determining submodule (not shown in the figure), configured to determine that the edge fragmentation progress of the first device is greater than the third predetermined progress when the quantity of fragmented edges of the first device is greater than an average quantity of fragmented edges of the plurality of devices, and an edge balance degree of the first device is greater than a predetermined edge balance degree, where the average quantity of fragmented edges and the edge balance degree are determined based on quantities of fragmented edges of the plurality of devices.

In an implementation, the second adjustment submodule 562 is further configured to decrease the adjusted first diffusion velocity by using the second correction factor when it is determined, based on comparison between the quantity of fragmented edges of the first device and the quantity of fragmented edges of the other device, that the edge fragmentation progress of the first device is less than a fourth predetermined progress.

In an implementation, the first adjustment module 560 further includes: a second determining submodule (not shown in the figure), configured to determine that the edge fragmentation progress of the first device is less than the fourth predetermined progress when the quantity of fragmented edges of the first device is not greater than an average quantity of fragmented edges, and a maximum edge balance degree in the plurality of devices is greater than a predetermined edge balance degree.

In an implementation, the second correction factor is determined based on comparison between the quantity of fragmented edges of the first device and an average quantity of fragmented edges of the plurality of devices.

The plurality of apparatus embodiments mentioned above correspond to the method embodiments. For detailed description, references can be made to the description of the method embodiments, and details are omitted here for simplicity. The apparatus embodiments are obtained based on the corresponding method embodiments, and have the same technical effects as the corresponding method embodiments. For detailed description, references can be made to the corresponding method embodiments.

One or more embodiments of this specification further provide a computer-readable storage medium. The computer-readable storage medium stores a computer program, and when the computer program is executed in a computer, the computer is enabled to perform the method in any of FIG. 1 to FIG. 3.

One or more embodiments of this specification further provide a computing device, including a memory and a processor. The memory stores executable code, and when executing the executable code, the processor implements the method in any of FIG. 1 to FIG. 3.

The embodiments of this specification are described in a progressive manner. For the same or similar parts of the embodiments, mutual references can be made between the embodiments. Each embodiment focuses on a difference from other embodiments. Particularly, the storage medium and computing device embodiments are basically similar to the method embodiments, and therefore are described briefly. For related parts, references can be made to the descriptions in the method embodiments.

A person skilled in the art should be aware that in the above-mentioned one or more examples, functions described in the embodiments of this specification can be implemented by hardware, software, firmware, or any combination thereof. When implemented by software, these functions can be stored in a computer-readable medium or transmitted as one or more instructions or code on a computer-readable medium.

The above-mentioned specific implementations further describe in detail the objectives, technical solutions, and beneficial effects of the embodiments of this specification. It should be understood that the previous descriptions are merely some specific implementations of the embodiments of this specification and are not intended to limit the protection scope of this specification. Any modification, equivalent replacement, or improvement made based on the technical solutions of this specification shall fall within the protection scope of this specification.

1. A method for performing data fragmentation on a knowledge graph, used to split a knowledge graph into a plurality of pieces of fragmented data, wherein the plurality of pieces of fragmented data are comprised in a plurality of devices, and the knowledge graph comprises a plurality of nodes representing entities and edges reflecting relations between nodes; and the method is performed by any first device in the plurality of devices and comprises:
obtaining a first part of edges of the knowledge graph, wherein the first part of edges are obtained after initial splitting is performed on a plurality of edges of the knowledge graph;
selecting a diffusion node from end nodes of the first part of edges based on a first diffusion velocity;
obtaining, as a to-be-fragmented edge, an edge that is in the knowledge graph and that uses the diffusion node as an end node on one side;
adding a target edge in the to-be-fragmented edge to first fragmented data, wherein the first fragmented data is comprised in the first device, and the first fragmented data comprises a fragmented edge;
obtaining an end node comprised in a fragmented edge in fragmented data of another device as a fragmented node of the other device;
adjusting the first diffusion velocity based on comparison between a fragmented node of the first device and the fragmented node of the other device; and
continuing to select a diffusion node based on an adjusted first diffusion velocity, and returning to perform the step of obtaining an edge that is in the knowledge graph and that uses the diffusion node as an end node on one side.

2. The method according to claim 1, wherein a value of the first diffusion velocity is between (0, 1], and is used to represent a selected quantity proportion.

3. The method according to claim 1, wherein the step of selecting a diffusion node from end nodes of the first part of edges based on a first diffusion velocity comprises:
selecting a first quantity of nodes from the end nodes of the first part of edges as initial boundary points;
sorting the plurality of initial boundary points in ascending order of quantities of edges associated with the initial boundary points; and
selecting the diffusion node from a plurality of sorted initial boundary points based on the first diffusion velocity.

4. The method according to claim 3, wherein the quantity of edges associated with the initial boundary point is determined by using the following method:
obtaining an edge that is in another device and that uses the initial boundary point as an end node on one side, wherein the other device comprises a device different from the first device in the plurality of devices, and the obtained edge is determined by the other device from a part of edges owned by the other device; and
determining, for any initial boundary point, the quantity of edges associated with the initial boundary point based on a sum of a quantity of edges that are in the first part of edges and that use the initial boundary point as an end node on one side and a quantity of edges that are in the other device and that use the initial boundary point as an end node on one side.

5. The method according to claim 1, wherein the step of obtaining an edge that is in the knowledge graph and that uses the diffusion node as an end node on one side comprises:
obtaining an edge that uses the diffusion node as an end node on one side from a part of edges owned by another device; and
determining, as the edge that is in the knowledge graph and that uses the diffusion node as an end node on one side, an edge that is in the obtained edge and the first part of edges and that uses the diffusion node as an end node on one side.

6. The method according to claim 1, wherein the target edge is determined from the to-be-fragmented edge in the following way:
selecting the target edge from the to-be-fragmented edge based on the first diffusion velocity.

7. The method according to claim 1, further comprising:
receiving an obtaining request sent by another device, wherein the obtaining request is used to obtain the fragmented node of the first device; and
sending the fragmented node of the first device to the other device, so that the other device adjusts a diffusion velocity of the other device based on the fragmented node of the first device.

8. The method according to claim 1, wherein the step of continuing to select a diffusion node based on an adjusted first diffusion velocity comprises:
selecting the diffusion node from an end node on the other side of the target edge based on the adjusted first diffusion velocity; or
selecting the diffusion node from an unselected end node in the first part of edges based on the adjusted first diffusion velocity.

9. The method according to claim 1, wherein the step of adjusting the first diffusion velocity based on comparison between a fragmented node of the first device and the fragmented node of the other device comprises:
decreasing the first diffusion velocity by using a first correction factor when it is determined, based on comparison between a quantity of fragmented nodes of the first device and a quantity of fragmented nodes of the other device, that a node fragmentation progress of the first device is greater than a first predetermined progress.

10. The method according to claim 9, wherein the following way is used to determine that the node fragmentation progress of the first device is greater than the first predetermined progress:
determining that the node fragmentation progress of the first device is greater than the first predetermined progress when the quantity of fragmented nodes of the first device is greater than an average quantity of fragmented nodes of the plurality of devices, and a node balance degree of the first device is greater than a predetermined node balance degree, wherein the average quantity of fragmented nodes and the node balance degree are determined based on quantities of fragmented nodes of the plurality of devices.

11. The method according to claim 9, further comprising:
increasing the first diffusion velocity by using the first correction factor when it is determined, based on comparison between the quantity of fragmented nodes of the first device and the quantity of fragmented nodes of the other device, that the node fragmentation progress of the first device is less than a second predetermined progress.

12. The method according to claim 11, wherein the following way is used to determine that the node fragmentation progress of the first device is less than the second predetermined progress:
determining that the node fragmentation progress of the first device is less than the second predetermined progress when the quantity of fragmented nodes of the first device is not greater than an average quantity of fragmented nodes, and a maximum node balance degree in the plurality of devices is greater than a predetermined node balance degree.

13. The method according to claim 9, wherein the step of decreasing the first diffusion velocity by using a first correction factor comprises:
decreasing the first diffusion velocity according to a logarithmic rule of the first correction factor.

14. The method according to claim 9, wherein the first correction factor is determined based on comparison between the quantity of fragmented nodes of the first device and an average quantity of fragmented nodes of the plurality of devices.

15. The method according to claim 1, before the adjusting the first diffusion velocity, further comprising:
obtaining a fragmented edge in fragmented data of another device; and
the step of adjusting the first diffusion velocity comprises:
adjusting the first diffusion velocity based on comparison between the fragmented node of the first device and a fragmented node of the other device, and comparison between the fragmented edge of the first device and the fragmented edge of the other device.

16. The method according to claim 15, wherein the step of adjusting the first diffusion velocity comprises:
preliminarily adjusting the first diffusion velocity based on comparison between the fragmented node of the first device and the fragmented node of the other device; and
continuing to adjust the adjusted first diffusion velocity based on comparison between the fragmented edge of the first device and the fragmented edge of the other device.

17. The method according to claim 16, wherein the step of continuing to adjust the adjusted first diffusion velocity based on comparison between the fragmented edge of the first device and the fragmented edge of the other device comprises:
decreasing the adjusted first diffusion velocity by using a second correction factor when it is determined, based on comparison between a quantity of fragmented edges of the first device and a quantity of fragmented edges of the other device, that an edge fragmentation progress of the first device is greater than a third predetermined progress.

18. The method according to claim 17, wherein the following way is used to determine that the edge fragmentation progress of the first device is greater than the third predetermined progress:
determining that the edge fragmentation progress of the first device is greater than the third predetermined progress when the quantity of fragmented edges of the first device is greater than an average quantity of fragmented edges of the plurality of devices, and an edge balance degree of the first device is greater than a predetermined edge balance degree, where the average quantity of fragmented edges and the edge balance degree are determined based on quantities of fragmented edges of the plurality of devices.

19. (canceled)

20. (canceled)

21. (canceled)

22. (canceled)

23. (canceled)

24. A non-transitory computer-readable storage medium, wherein the computer-readable storage medium stores a computer program, and when the computer program is executed in a computer, the computer is enabled to perform the method according to claim 1.

25. A computing device, comprising a memory and a processor, wherein the memory stores executable code, and when the processor executes the executable code, the method according to claim 1 is implemented.
